(19) United States
(12) Patent Application Publication
(10) Pub. No.: US 2007/0022641 A1
(43) Pub. Date: Feb. 1, 2007

(54) Self-assembling table tent insert

(75) Inventor: Kenn Goldblatt, Fort Worth, TX (US)

Correspondence Address: Kenn Goldblatt, 3605 Wharton Drive, Fort Worth, TX, 76133, US

(73) Assignee: TableTop Promotions, Inc., a Texas Corporation, Fort Worth, TX (US)

(21) Appl. No.: 11/190,535

(22) Filed: Jul. 28, 2005

(51) Int. Cl. G09F 1/10

(52) U.S. Cl. 40/124.4; 40/539

(57) ABSTRACT

The claimed design combines a traditionally printed, scored and perforated carrier sheet that can be over-printed with a point-of-sale advertising or marketing message using a microcomputer-driven printer or copier prior to the Insert's placement into a plastic holder with matching perimeter shape. The Insert consists of an individual sheet of paper of sufficient grade and weight to provide tension to hold all parts of the Insert in proper alignment using its “bowed” bottom section that is a feature of its design. The bowed bottom section provides a constant and continuing pressure to hold the separate folds of the Insert snuggly against the lower inside walls of the plastic holder as it simultaneously maintains its proper vertical alignment within the upper segment of the holder.

The design is used to stabilize and adjust the paper Insert used inside a free-standing, plastic, sign Holder used for retail advertising, promotion, sales and/or other messaging purposes. The claim concerns the way the paper Insert is designed and manufactured so that it can be 1) printed (or over-printed) in a microcomputer-controlled printing device or copier as a standard-sized piece of paper, 2) then separated from the standard-sized “carrier sheet” into a uniquely shaped finished piece that matches the outside dimensions of the matching plastic Holder, and 3) then folded in a manner to stabilize and align the paper Insert as it is held within the plastic Holder and to press the paper held within the Holder's triangular base snugly against the inside surfaces of the Holder's base.

### CROSS-REFERENCES

The Applicant has filed three (3) additional design claims for Decorative (plastic) Holders for Self-Assembling Paper Inserts—Table Tents featuring different Front View shapes and three (4) copyright claims for illustrations used on Self-Assembling Table Tent Inserts for each of the three Holder shapes claimed, as well as this utility patent for Self-Assembling Table Tent Inserts. Applicant will also file a utility patent for associated business processes. Other claims will likely be asserted as the product line utilizing the techniques claimed here is developed.

### STATEMENT REGARDING FEDERALLY SPONSORED RESEARCH OR DEVELOPMENT

Not Applicable.

### UTILITY DESCRIPTION

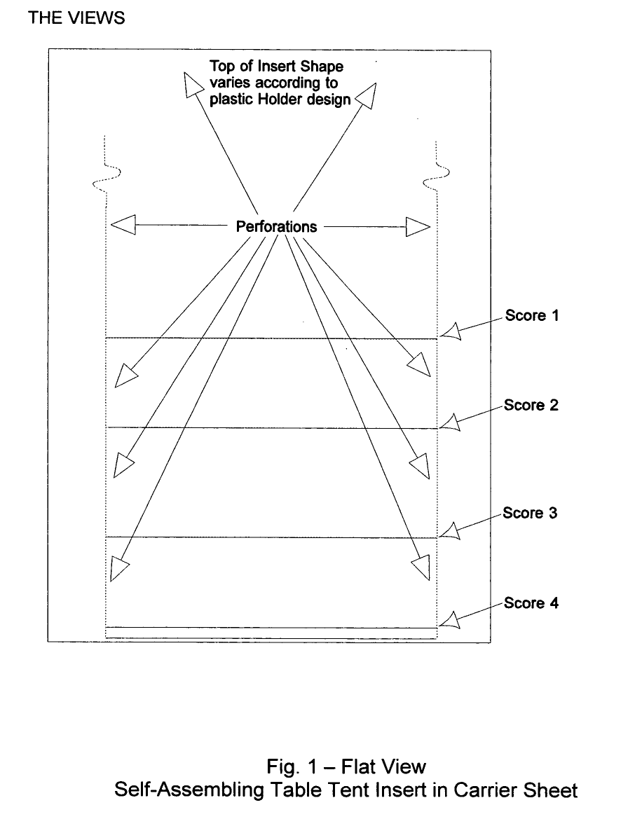

FIG. 1: Flat drawing showing perforated and scored paper “carrier sheet” holding the perforated and scored unique shape of Self-Assembling Table Tent Insert.

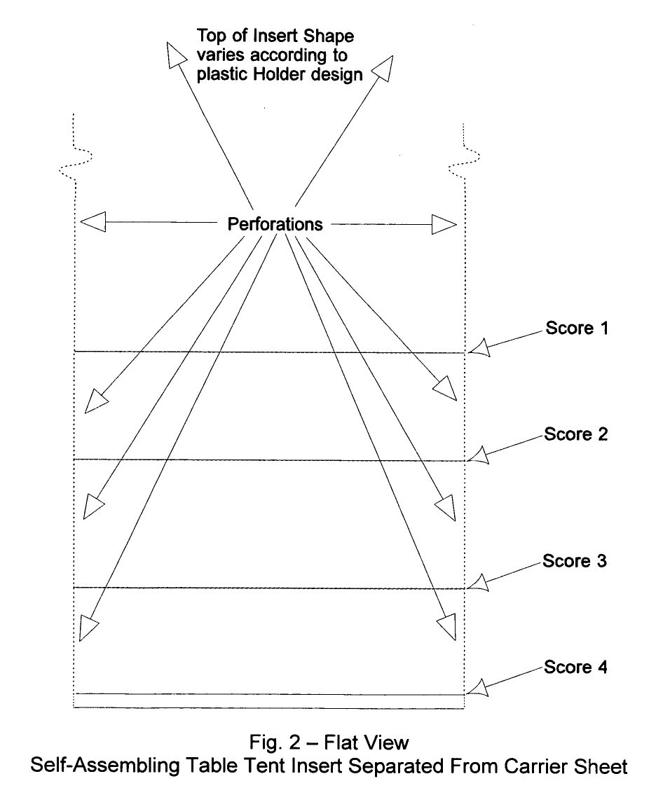

FIG. 2: Flat drawing showing the perforated and scored Self-Assembling Table Tent Insert separated from the original “carrier sheet.”

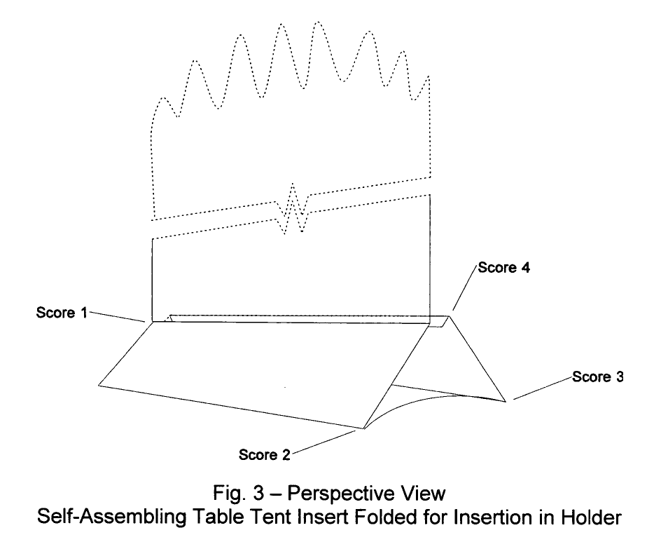

FIG. 3: Perspective view showing scoring pattern and bowing characteristic for self-assembly feature of Self-Assembling Table Tent Insert.

The Self-Assembling Table Tent Insert is held upright in its uniquely shaped plastic Holder, the irregular outside dimensions of which are identical to a portion of the perforation pattern on the “paper carrier” holding the Self-Assembling Table Tent Insert.

### FEATURE DESCRIPTION

Self-Assembling Table Tent Inserts are printed on individual sheets of paper of sufficient grade and weight to allow the unique perimeter shape designs of the matching Holders to be perforated into the “carrier sheet” and scored at four separate points to facilitate folding, insertion and assembly into the matching Holder. Once the Insert has been locally printed with individual messages, the perforations are used to remove the Insert from its paper carrier. The scores assist in folding the Insert for insertion into its matching plastic Holder.

Self-Assembling Table Tent Inserts are designed to be displayed in matching, freestanding plastic Holders to provide individualized marketing, sales, promotional and other types of messages for point-of-sale messaging in a variety of situations. The Self-Assembling Table Tent Inserts are designed to allow users up to four discrete message areas on the two sides of the Insert on which messages can be observed by prospective customers or constituent audiences.

As an integral part of their design, Self-Assembling Table Tent Inserts include an over-sized bottom section that, when inserted in a matching Holder, are arranged to be slightly bowed. This bowing feature serves two purposes: 1) it allows the paper insert to be adjusted to accommodate manufacturing variances in the Holder's triangular base area while it maintains the alignment and fit between the paper Insert and its plastic Holder, and 2) it provides continuing tension to hold the separate folds of the Self-Assembling Table Tent Insert snuggly against the inside walls of the plastic holder and maintain the Insert's alignment with the Holder.

1. The utilitarian design using this unique combination of perforations, scoring, and folding for a Self-Assembling Table Tent Insert represents a single claim. Insert shapes matching the Holder design represent separate claims for patent and/or copyright. Holder design claims represent separate claims for design patents.
